(19) United States
(12) Patent Application Publication
(10) Pub. No.: US 2010/0250373 A1
(43) Pub. Date: Sep. 30, 2010

(54) Method and system of online shopping using blog

(76) Inventor: Nankuei Lin, Taipei (TW)

Correspondence Address: SAM CHEN, 7F-1, 293, ROOSEVELT ROAD, SEC 3, TAIPEI, TW

(21) Appl. No.: 12/409,518

(22) Filed: Mar. 24, 2009

(51) Int. Cl. G06Q 30/00; G06F 15/16

(52) U.S. Cl. 705/14.73; 705/27; 705/34; 709/206

(57) ABSTRACT

A system of online shopping includes a plurality of buyer terminals (1); a plurality of seller terminals (2); a plurality of web servers (3) comprising a plurality of seller blogs (31) including a plurality of item description web pages (31W); an online billing platform (4); and a plurality of bank terminals (5), wherein the buyer terminals (1), the seller terminals (2), the web servers (3), the online billing platform (4), and the bank terminals (5) are connected together via the Internet (6). A method of online shopping using blog is also provided.

### BACKGROUND OF THE INVENTION

1. Field of Invention

The invention relates to e-business and more particularly to method and system of online shopping (i.e., buying and sale goods and services on the Internet) using a blog.

2. Description of Related Art

A blog is a type of personal diary posted on the Internet. Most blogs consist of small, plentiful entries. Topics posted on blogs may vary widely.

Conventionally, e-business is not possible using blog. This is because only data like pictures and documents are typically transmitted by a web server. High cost and technological difficulties make e-business using blog almost infeasible.

Currently, there are many websites providing online shopping. Typically, an item and a brief description thereof are shown on a web page. Hence, a would-be buyer may not know details of a desired item by simply viewing the web page. This may greatly decrease buying desire of many would-be buyers. A lot of restrictions are also applied on web pages provided by the online auction and shopping websites. This may further frustrate many would-be sellers.

Thus, it is desirable to provide a novel method and system of online shopping using a blog in order to fully utilize the features of blog.

### SUMMARY OF THE INVENTION

It is therefore one object of the invention to provide a method of online shopping using a blog.

It is another object of the invention to provide a system of online shopping using a blog.

The above and other objects, features and advantages of the invention will become apparent from the following detailed description taken with the accompanying drawings.

### BRIEF DESCRIPTION OF THE DRAWINGS

FIG. 1 is a block diagram schematically depicting a first preferred embodiment of system of online shopping using blog according to the invention;

FIG. 2 is a block diagram schematically depicting the online billing platform of FIG. 1;

FIG. 3 is a block diagram schematically depicting a second preferred embodiment of system of online shopping using blog according to the invention; and

FIG. 4 is a block diagram schematically depicting the online billing platform of FIG. 3.

### DETAILED DESCRIPTION OF THE INVENTION

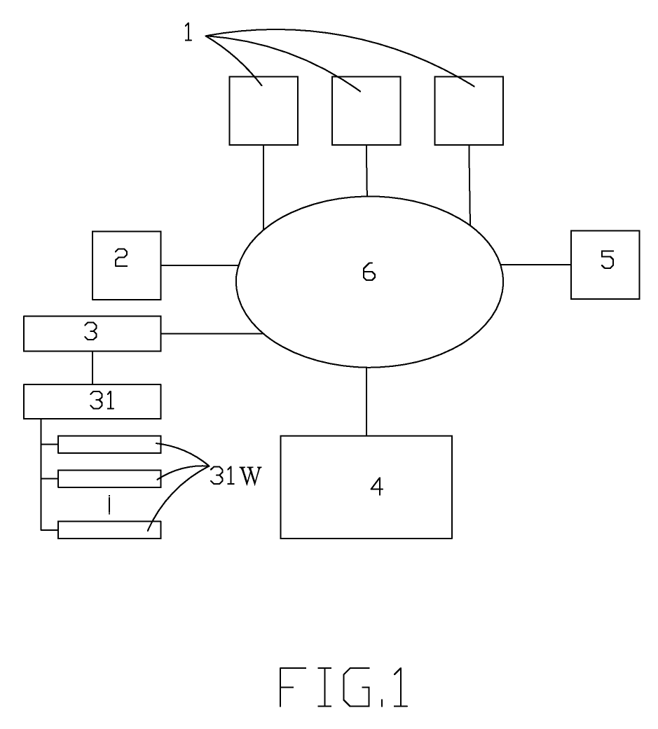

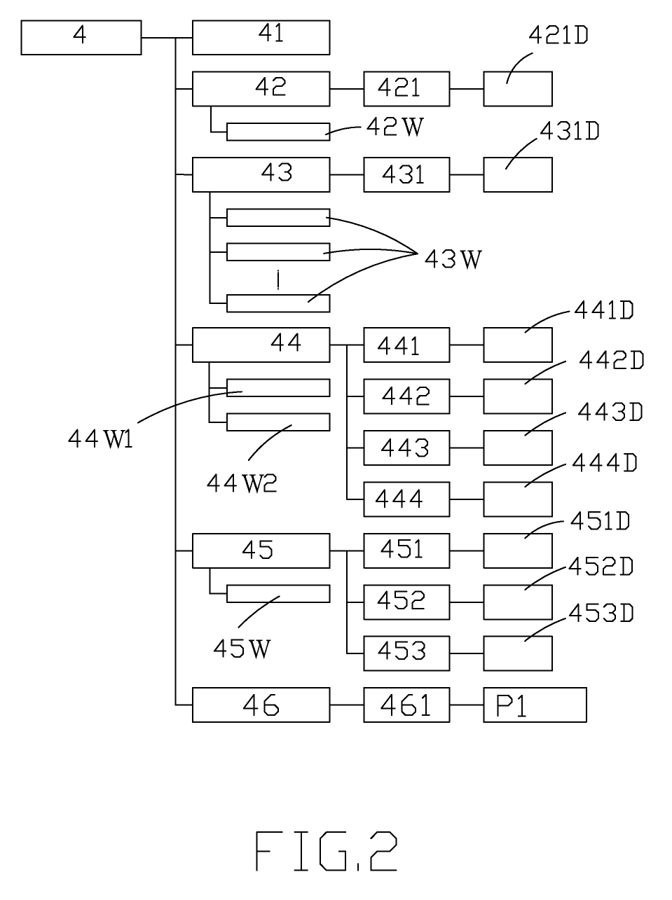

Referring to FIGS. 1 and 2, a system of online shopping using blog in accordance with a first preferred embodiment of the invention is shown. The system comprises a plurality of user (i.e., would-be buyer) terminals 1, a plurality of seller terminals (only one is shown) 2, a plurality of web servers (only one is shown) 3, an online billing platform 4, and a plurality of bank terminals (only one is shown) 5 all being connected together via the Internet 6.

The web server 3 comprises a plurality of seller blogs (only one is shown) 31. The online billing platform 4 comprises a platform server 41, a login server 42, an item server 43, a billing server 44, an e-mail server 45, and a function server 46 all being connected together by wires.

The login server 42 comprises a member database 421. The item server 43 comprises a merchandise database 431. The billing server 44 comprises a purchase order database 441, a bank database 442, a shipment database 443, and a debit note database 444. The e-mail server 45 comprises an e-mail database 451, a client database 452, and an advertisement database 453. The function server 46 comprises a program database 461 having a transaction tab program P1. The transaction tab program P1 comprises a guide tab and a payment tab.

The method of online shopping using blog in accordance with a first preferred embodiment of the invention comprises the following steps.

A seller may use a seller terminal 2 to access a seller blog 31 of the web server 3 over the Internet 6. The seller then creates an item description web page 31W in the seller blog 31. A number of pictures and accompanying description of items being sold are posted on the item description web page 31W. The seller then uses the seller terminal 2 to access the platform server 41 via the Internet 6. Next, the seller gains access to a member web page 42W of the login server 42 and types personal data 421D in order to apply for membership.

After becoming a member, a seller may gain access to the platform server 41 via the Internet 6. Next, it is connected to the login server 42. Next, user name and password are typed for identification. After being identified, the seller may gain access to the program database 461. Next, program codes of the transaction tab program P1 are copied to the seller based on his or her rights and a desired shopping mode. Next, the seller may use the program codes of the transaction tab program P1 in his or her seller terminal 2 to link to a seller blog 31. After successfully linking, the seller may download program codes of the transaction tab program P1 to the seller blog 31. Thus, program codes of the transaction tab program P1 may be installed in the item description web page 31W. Also, the guide tab and the payment tab of the transaction tab program P1 are installed in the item description web page 31W. Note that the payment tab is disabled.

A seller may click the guide tab of the item description web page 31W of the seller blog 31 to link the item description web page 31W of the seller blog 31 to the platform server 41 of the online billing platform 4 via the Internet 6. Next, it is linked to the login server 42. Next, user name and password are typed for identification. After being identified, the seller is linked to the item server 43. Next, a number of pictures and accompanying description of items being sold on the item description web page 31W of the seller blog 31 are downloaded to the merchandise database 431 of the item server 43. Next, a merchandise file 431D is created in the merchandise database 431. Next, the online billing platform 4 may send an instruction to the transaction tab program P1 of the item description web page 31W of the seller blog 31 via the Internet 6. Next, the payment tab of the item description web page 31W of the seller blog 31 is enabled. This means that the item description web page 31W of the seller blog 31 with respect to an item is successfully created. Thus, it is possible of clicking the payment tab for further processing.

A plurality of merchandise sale web pages 43W each together with the enabled payment tab and a link tab are created in the item server 43 after the creation of the merchandise file 431D. Next, click the link tab to link the platform server 41 of the online billing platform 4 to the item description web page 31W of the seller blog 31 in order to provide details of pictures and accompanying description of items being sold.

A user (i.e., would-be buyer) may use a user terminal 1 to link to a seller blog 31 via a web server 3 so as to view the pictures and accompanying description of items being sold on the item description web page 31W of the seller blog 31. The user may click the payment tab on the item description web page 31W if he or she wants to buy one or more items therefrom.

Alternatively, a user may use a user terminal 1 to link to a platform server 41 of the online billing platform 4 and in turn link to an item server 43 in order to view pictures and accompanying description of items being sold on the merchandise sale web page 43W of the item server 43. The user may click the payment tab on the merchandise sale web page 43W if he or she wants to buy one or more items therefrom.

Still alternatively, a user may click the link tab of the merchandise sale web page 43W to link the platform server 41 of the online billing platform 4 to the item description web page 31W of the seller blog 31 on the web server 3 in order to view pictures and accompanying description of items being sold thereon.

The method of online shopping using blog further comprises the following steps:

A seller may use a seller terminal 2 to link to a platform server 41 of the online billing platform 4 and in turn link to a login server 42. Next, user name and password are typed for identification. After being identified, the seller may link to an e-mail server 45 to send a client file to a client database 452 of the e-mail server 45. And in turn, a corresponding client record file 452D is created. The e-mail server 45 of the online billing platform 4 may create an advertisements issuing web page 45W based on the client record file 452D and the merchandise file 431D.

The seller may use a seller terminal 2 to link to a platform server 41 of the online billing platform 4 and in turn link to a login server 42. Next, user name and password are typed for identification. After being identified, the seller may link to an advertisements issuing web page 45W of an e-mail server 45. Also, the seller is required to input a client list and information about merchandise being sold on the advertisements issuing web page 45W required for advertisement purposes. A issued advertisements file 453D is created in the advertisement database 453 of the e-mail server 45 based on the client list and information about merchandise being sold. The e-mail server 45 then sends the issued advertisements file 453D to a would-be buyer by e-mail. Note that the payment tab contained in the e-mail has been enabled. Hence, the would-be buyer may click the payment tab to start a payment procedure.

A payment procedure involves the following steps: A user (i.e., would-be buyer) may click the payment tab to link to a platform server 41 of the online billing platform 4 and in turn link to a login server 42. Next, user name and password are typed for identification. After being identified, the user may link to a payment web page 44W1 of a billing server 44. Also, the user is required to input payment data on the payment web page 44W1. A purchase order file with order number 441D is created in the purchase order database 441 of the billing server 44 based on the payment data.

The platform server 41 of the online billing platform 4 links to a bank terminal 5. The billing server 44 then verifies information (e.g., credit card information) provided in the purchase order file with order number 441 D with a corresponding credit card issuing bank. After being verified, a transaction particulars file with order number 442D is created in a bank database 442 of the billing server 44 based on an authorization from the bank. Also, a shipment file with order number 443D is created in the shipment database 443 of the billing server 44.

The e-mail server 45 then sends the purchase order file with order number 441D to the seller by e-mail. Also, the e-mail server 45 then sends an e-mail to inform the seller to prepare the ordered item for shipment based on the shipment file with order number 443D.

The method of online shopping using blog further comprises the following steps:

After successfully shipping the goods, the seller may use a seller terminal 2 to link to a platform server 41 of the online billing platform 4 and in turn link to a login server 42. Next, user name and password are typed for identification. After being identified, the seller may link to a request for payment web page 44W2 of the billing server 44. Also, the seller is required to input payment data on the request for payment web page 44W2. A debit note file with order number 444D is created in the debit note database 444 of the billing server 44 based on the payment data.

After being verified by the online billing platform 4, an invoice is prepared based on the debit note file with order number 444D. The invoice is finally issued to the buyer for request for payment.

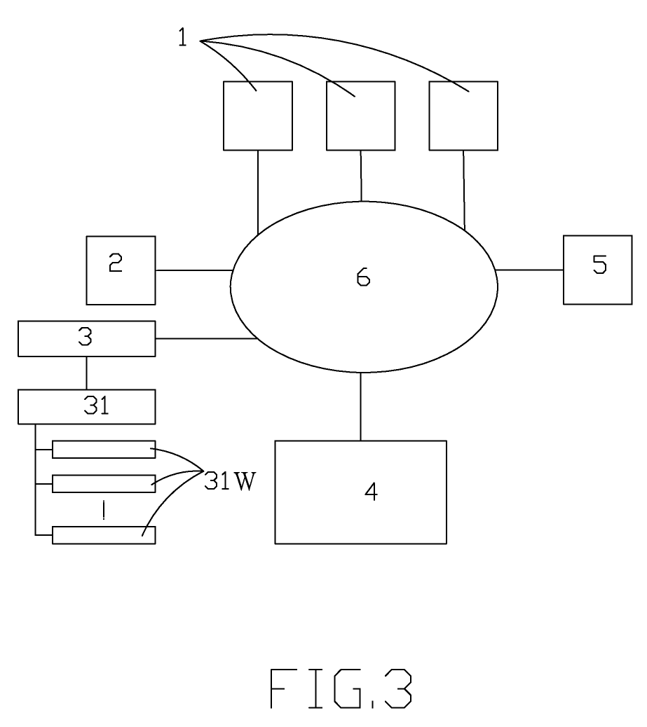

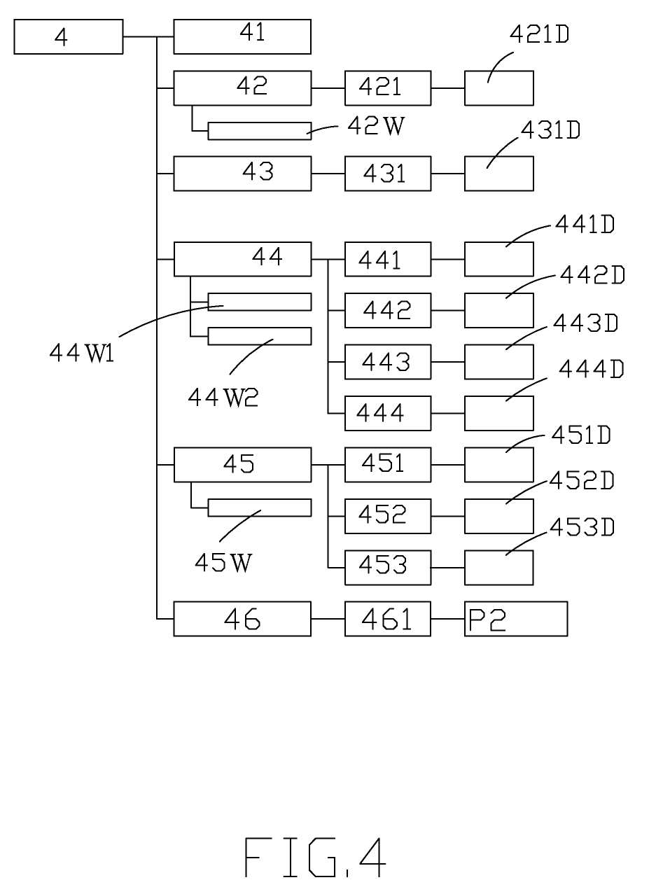

Referring to FIGS. 3 and 4, a system of online shopping using blog in accordance with a second preferred embodiment of the invention is shown. The system comprises a plurality of user (i.e., would-be buyer) terminals 1, a plurality of seller terminals 2, a plurality of web servers (only one is shown) 3, an online billing platform 4, and a plurality of bank terminals 5 all being connected together via the Internet 6.

The web server 3 comprises a plurality of seller blogs (only one is shown) 31. The online billing platform 4 comprises a platform server 41, a login server 42, an item server 43, a billing server 44, an e-mail server 45, and a function server 46 all being connected together by wires.

The login server 42 comprises a member database 421. The item server 43 comprises a merchandise database 431. The billing server 44 comprises a purchase order database 441, a bank database 442, a shipment database 443, and a debit note database 444. The e-mail server 45 comprises an e-mail database 451, a client database 452, and an advertisement database 453. The function server 46 comprises a program database 461 having a sale tab program P2. The sale tab program P2 comprises a guide tab and a payment tab.

The method of online shopping using blog in accordance with a first preferred embodiment of the invention comprises the following steps.

A seller may use a seller terminal 2 to access a seller blog 31 of the web server 3 over the Internet 6. The seller then creates an item description web page 31W in the seller blog 31. A number of pictures and accompanying description of items being sold are posted on the item description web page 31W. Note that the sellers are employees of a company and the merchandise being sold is produced by the company. These items to be sold are posted on the item description web page 31W of the seller blog 31 on the web server 3.

A manager of the online billing platform 4 may create a merchandise file 431D in the merchandise database 431. The seller then uses the seller terminal 2 to access the platform server 41 via the Internet 6. Next, the seller gains access to a member web page 42W of the login server 42 and types personal data 421D in order to apply for membership.

After becoming a member, a seller may gain access to the platform server 41 via the Internet 6. Next, it is connected to the login server 42. Next, user name and password are typed for identification. After being identified, the seller may gain access to the program database 461. Next, program codes of the sale tab program P2 are copied to the seller based on his or her rights and a desired shopping mode. Next, the seller may use the program codes of the sale tab program P2 in his or her seller terminal 2 to link to a seller blog 31. After successfully linking, the seller may download program codes of the sale tab program P2 to the seller blog 31. Thus, program codes of the sale tab program P2 may be installed in the item description web page 31W. Also, the guide tab and the payment tab of the sale tab program P2 are installed in the item description web page 31W. Note that the payment tab has been enabled. Hence, the would-be buyer may click the payment tab to start a payment procedure.

A user (i.e., would-be buyer) may use a user terminal 1 to link to a seller blog 31 via a web server 3 so as to view the pictures and accompanying description of items being sold on the item description web page 31W of the seller blog 31. The user may click the payment tab on the item description web page 31W if he or she wants to buy one or more items therefrom. Next, a payment procedure is started automatically.

The method of online shopping using blog further comprises the following steps:

A seller may use a seller terminal 2 to link to a platform server 41 of the online billing platform 4 and in turn link to a login server 42. Next, user name and password are typed for identification. After being identified, the seller may link to an e-mail server 45 to send a client file to a client database 452 of the e-mail server 45. And in turn, a corresponding client record file 452D is created. The e-mail server 45 of the online billing platform 4 may create an advertisements issuing web page 45W based on the client record file 452D and the merchandise file 431D.

The seller may use a seller terminal 2 to link to a platform server 41 of the online billing platform 4 and in turn link to a login server 42. Next, user name and password are typed for identification. After being identified, the seller may link to an advertisements issuing web page 45W of an e-mail server 45. Also, the seller is required to input a client list and information about merchandise being sold on the advertisements issuing web page 45W required for advertisement purposes. A issued advertisements file 453D is created in the advertisement database 453 of the e-mail server 45 based on the client list and information about merchandise being sold. The e-mail server 45 then sends the issued advertisements file 453D to a would-be buyer by e-mail. Note that the payment tab contained in the e-mail has been enabled. Hence, the would-be buyer may click the payment tab to start a payment procedure.

A payment procedure involves the following steps: A user (i.e., would-be buyer) may click the payment tab to link to a platform server 41 of the online billing platform 4 and in turn link to a login server 42. Next, user name and password are typed for identification. After being identified, the user may link to a payment web page 44W1 of a billing server 44. Also, the user is required to input payment data on the payment web page 44W1. A purchase order file with order number 441D is created in the purchase order database 441 of the billing server 44 based on the payment data.

The platform server 41 of the online billing platform 4 links to a bank terminal 5. The billing server 44 then verifies information (e.g., credit card information) provided in the purchase order file with order number 441D with a corresponding credit card issuing bank. After being verified, a transaction particulars file with order number 442D is created in a bank database 442 of the billing server 44 based on an authorization from the bank. Also, a shipment file with order number 443D is created in the shipment database 443 of the billing server 44.

The e-mail server 45 then sends the purchase order file with order number 441D to the seller by e-mail. Also, the e-mail server 45 then sends an e-mail to inform the seller to prepare the ordered item for shipment based on the shipment file with order number 443D.

The method of online shopping using blog further comprises the following steps:

After successfully shipping the goods, the seller may use a seller terminal 2 to link to a platform server 41 of the online billing platform 4 and in turn link to a login server 42. Next, user name and password are typed for identification. After being identified, the seller may link to a request for payment web page 44W2 of the billing server 44. Also, the seller is required to input payment data on the request for payment web page 44W2. A debit note file with order number 444D is created in the debit note database 444 of the billing server 44 based on the payment data.

After being verified by the manager of the online billing platform 4, an invoice is prepared based on the debit note file with order number 444D. The invoice is finally issued to the buyer for request for payment.

While the invention herein disclosed has been described by means of specific embodiments, numerous modifications and variations could be made thereto by those skilled in the art without departing from the scope and spirit of the invention set forth in the claims.

What is claimed is:

1. A system of online shopping comprising:
a plurality of would-be buyer terminals (1);
a plurality of seller terminals (2);
a plurality of web servers (3) comprising a plurality of seller blogs (31) including a plurality of item description web pages (31W);
an online billing platform (4); and
a plurality of bank terminals (5),
wherein the would-be buyer terminals (1), the seller terminals (2), the web servers (3), the online billing platform (4), and the bank terminals (5) are connected together via the Internet (6).

2. The system of claim 1, wherein the online billing platform (4) comprises:
a platform server (41);
a login server (42) including a member database (421);
an item server (43) including a merchandise database (431);
a billing server (44) including a purchase order database (441), a bank database (442), a shipment database (443), and a debit note database (444);
an e-mail server (45) including an e-mail database (451), a client database (452), and an advertisement database (453); and
a function server (46) including a program database (461) having a transaction tab program (P1).

3. A method of online shopping comprising the steps of:
at a seller:
using a seller terminal (2) to access a seller blog (31) of a web server (3) over the Internet (6);
creating an item description web page (31W) in the seller blog (31) wherein at least one picture and accompanying description of an item being sold are posted on the item description web page (31W);
using the seller terminal (2) to access a platform server (41) via the Internet (6);
gaining access to a member web page (42W) of a login server (42) and typing personal data (421D) for membership application;
after becoming a member, gaining access to the platform server (41) via the Internet (6);
linking to the login server (42);
logging in for gaining access to a program database (461);
copying program codes of a transaction tab program (P1) to the seller;
using the program codes of the transaction tab program (P1) in the seller terminal (2) to link to the seller blog (31); downloading the program codes of the transaction tab program (P1) to the seller blog (31) for installing in the item description web page (31W);
installing a guide tab and a payment tab of the transaction tab program (P1) in the item description web page (31W);
clicking the guide tab of the item description web page (31W) to link the item description web page (31W) to the platform server (41) and the login server (42) via the Internet (6);
logging in for linking to an item server (43);
downloading at least one picture and accompanying description of an item being sold on the item description web page (31W) to a merchandise database (431) of the item server (43);
creating a merchandise file (431 D) in the merchandise database (431);
causing an online billing platform (4) to send an instruction to the transaction tab program (P1) via the Internet (6);
enabling the payment tab of the item description web page (31W);
creating a merchandise sale web page (43W) together with the enabled payment tab and a link tab in the item server (43); and
clicking the link tab to link the platform server (41) to the item description web page (31W) for providing details of the at least one picture and accompanying description of an item being sold;
at a buyer:
using a user terminal (1) to link to the seller blog (31) via the web server (3) so as to view the at least one picture and accompanying description of an item being sold on the item description web page (31W);
clicking the payment tab on the item description web page (31W) for buying the item;
clicking the payment tab to link to the platform server (41) and the login server (42);
logging in for linking to a payment web page (44W1) of a billing server (44);
inputting payment data on the payment web page (44W1) to create a purchase order file with order number (441D) in a purchase order database (441);
linking the platform server (41) to a bank terminal (5); and
causing the billing server (44) to verify credit card information provided in the purchase order file with order number (441D) with a corresponding credit card issuing bank;
after being verified, creating a transaction particulars file with order number (442D) in a bank database (442) of the billing server (44);
creating a shipment file with order number (443D) in a shipment database (443) of the billing server (44);
causing an e-mail server (45) to send the purchase order file with order number (441 D) to the seller by e-mailing and inform the seller to prepare the item for shipment based on the shipment file with order number (443D) by e-mailing;
after shipping the item, instructing the seller to use the seller terminal (2) to link to the platform server (41) and the login server (42);
logging in for linking to a request for payment web page (44W2) of the billing server (44);
inputting payment data on the request for payment web page (44W2);
creating a debit note file with order number (444D) in a debit note database (444) of the billing server (44) based on the payment data; and
after being verified by the online billing platform (4), issuing an invoice based on the debit note file with order number (444D).

4. The method of claim 3, further comprising the steps of:
causing the seller to use the seller terminal (2) to access the platform server (41) and link to the login server (42);
logging in for linking to the e-mail server (45) to send a client file to a client database (452) of the e-mail server (45);
creating a corresponding client record file (452D); and
causing the e-mail server (45) to create an advertisements issuing web page (45W) based on the client record file (452D) and the merchandise file (431D).

5. The method of claim 4, further comprising the steps of:
causing the seller to use the seller terminal (2) to access the platform server (41) and link to the login server (42);
logging in for linking to the advertisements issuing web page (45W);
causing the seller to input a client list and information about the at least one item being sold on the advertisements issuing web page (45W);
creating a issued advertisements file (453D) in the advertisement database (453) of the e-mail server (45); and
causing the e-mail server (45) to send the issued advertisements file (453D) to the buyer by e-mailing with the enabled payment tab contained therein.

6. A method of online shopping comprising the steps of:
at a seller:
using a seller terminal (2) to access a seller blog (31) of a web server (3) over the Internet (6);
creating an item description web page (31W) in the seller blog (31) wherein at least one picture and accompanying description of an item being sold are posted on the item description web page (31W);
using the seller terminal (2) to access a platform server (41) via the Internet (6);
gaining access to a member web page (42W) of a login server (42) and typing personal data (421D) for membership application;
after becoming a member, gaining access to the platform server (41) via the Internet (6);
linking to the login server (42);
logging in for gaining access to a program database (461);
copying program codes of a sale tab program (P2) to the seller;
using the program codes of the sale tab program (P2) in the seller terminal (2) to link to the seller blog (31);
downloading the program codes of the sale tab program (P2) to the seller blog (31) for installing in the item description web page (31W);
installing a guide tab and a payment tab of the sale tab program (P2) in the item description web page (31W);
clicking the guide tab of the item description web page (31W) to link the item description web page (31W) to the platform server (41) and the login server (42) via the Internet (6);
logging in for linking to an item server (43);
downloading at least one picture and accompanying description of an item being sold on the item description web page (31W) to a merchandise database (431) of the item server (43);
creating a merchandise file (431D) in the merchandise database (431);
causing an online billing platform (4) to send an instruction to the sale tab program (P2) via the Internet (6);
enabling the payment tab of the item description web page (31W); and
clicking a link tab to link the platform server (41) to the item description web page (31W) for providing details of the at least one picture and accompanying description of an item being sold;
at a buyer:
using a user terminal (1) to link to the seller blog (31) via the web server (3) so as to view the at least one picture and accompanying description of an item being sold on the item description web page (31W);
clicking the payment tab on the item description web page (31W) for buying the item;
clicking the payment tab to link to the platform server (41) and the login server (42);
logging in for linking to a payment web page (44W1) of a billing server (44);
inputting payment data on the payment web page (44W1) to create a purchase order file with order number (441 D) in a purchase order database (441);
linking the platform server (41) to a bank terminal (5); and
causing the billing server (44) to verify credit card information provided in the purchase order file with order number (441 D) with a corresponding credit card issuing bank;
after being verified, creating a transaction particulars file with order number (442D) in a bank database (442) of the billing server (44);
creating a shipment file with order number (443D) in a shipment database (443) of the billing server (44);
causing an e-mail server (45) to send the purchase order file with order number (441D) to the seller by e-mailing and inform the seller to prepare the item for shipment based on the shipment file with order number (443D) by e-mailing;
after shipping the item, instructing the seller to use the seller terminal (2) to link to the platform server (41) and the login server (42);
logging in for linking to a request for payment web page (44W2) of the billing server (44);
inputting payment data on the request for payment web page (44W2);
creating a debit note file with order number (444D) in a debit note database (444) of the billing server (44) based on the payment data; and
after being verified by the online billing platform (4), issuing an invoice based on the debit note file with order number (444D).

7. The method of claim 6, further comprising the steps of:
causing the seller to use the seller terminal (2) to access the platform server (41) and link to the login server (42);
logging in for linking to the e-mail server (45) to send a client file to a client database (452) of the e-mail server (45);
creating a corresponding client record file (452D); and
causing the e-mail server (45) to create an advertisements issuing web page (45W) based on the client record file (452D) and the merchandise file (431D).

8. The method of claim 7, further comprising the steps of:
causing the seller to use the seller terminal (2) to access the platform server (41) and link to the login server (42);
logging in for linking to the advertisements issuing web page (45W);
causing the seller to input a client list and information about the at least one item being sold on the advertisements issuing web page (45W);
creating a issued advertisements file (453D) in the advertisement database (453) of the e-mail server (45); and
causing the e-mail server (45) to send the issued advertisements file (453D) to the buyer by e-mailing with the enabled payment tab contained therein.
